(19) United States
(12) Patent Application Publication
(10) Pub. No.: US 2010/0035101 A1
(43) Pub. Date: Feb. 11, 2010

(54) Fuel cell unit and method for producing an eletrically conductive connection between an electrode and a bipolar plate

(75) Inventors: Uwe Maier, Reutlingen (DE); Thomas Kiefer, Bad Urach (DE); Andreas Zimmer, Metzingen (DE)

Correspondence Address: Mr. Edward J. Timmer, 121 East Front Street-Suite 205, Traverse City, MI, 49684, US

(73) Assignee: ElringKlinger AG

(21) Appl. No.: 12/456,407

(22) Filed: Sep. 3, 2009

(30) Foreign Application Priority Data
Aug. 7, 2008 (DE) 10 2008 036 847.4

(51) Int. Cl. H01M 8/00; H01M 2/02

(52) U.S. Cl. 429/13; 429/34

(57) ABSTRACT

In order to create a fuel cell unit, comprising a cathode-electrolyte-anode unit and at least one bipolar plate which is connected to an electrode of the cathode-electrolyte-anode unit in an electrically conductive manner, which has a low contact resistance between the bipolar plate and an electrode of the cathode-electrolyte-anode unit, it is suggested that the fuel cell unit comprise at least one electrically conductive intermediate element which is arranged between the bipolar plate and the electrode and has at least one contact surface facing the electrode.

The present disclosure relates to the subject matter disclosed in the German patent application No. 10 2008 036 847.4 of Aug. 7, 2008. The entire specification of this earlier application is incorporated in the present specification by reference.

The present invention relates to a fuel cell unit which comprises a cathode-electrolyte-anode unit and at least one bipolar plate which is connected to an electrode of the cathode-electrolyte-anode unit in an electrically conductive manner.

Since a fuel cell unit has only a low individual cell voltage of approximately 0.4 V to approximately 1.2 V (depending on the load), a series connection of several electrochemical cells in one fuel cell stack is required, whereby the initial voltage is scaled into a range which is of interest from the point of view of technical application. For this purpose, the individual electrochemical cells will be connected by means of so-called bipolar plates (also designated as interconnectors).

Such a bipolar plate must meet the following requirements:
Distribution of the media (combustible gas and/or oxidizing agent).
Sufficient electrical conductivity since, within the fuel cell stack, the electrons generated at the hydrogen side (anode) are conveyed through the bipolar plates in order to be available to the air side (cathode) of the next electrochemical cell. In order, in this respect, to keep the electrical losses low, the material for the bipolar plates must have an adequately high electrical conductivity.
Sufficient corrosion resistance since the typical operating conditions of a fuel cell unit (operating temperature approximately 800° C., oxidizing/reducing atmosphere, moist air) act in a corrosion-promoting manner. For this reason, the requirements which are placed on the corrosion resistance of the material of the bipolar plate are high.

Normally, chromium oxide-forming steels are used as material for the bipolar plates of high temperature fuel cells. One reason for this is the relatively good electrical conductivity of the self-forming chromium oxide layer in comparison with the insulating oxide layers which are formed by other high-temperature steels or alloys (e.g., by aluminum oxide or silicone oxide forming agents).

One disadvantage of the chromium oxide forming agent is, on the other hand, the volatilization of volatile chromium species at the operating conditions of the fuel cell. This “chromium volatilization” results in a poisoning of the cathode, the consequence of which is a degradation of the cell output.

It is known to use a sheet metal, which is stamped from a basic metallic material and has, for example, a wave-like profile or a nap-like profile, as bipolar plate. In this respect, the “valleys” of the profile ensure an adequate supply of gas to the cathode-electrolyte-anode unit (with oxidizing agent or with combustible gas). The “peaks” of the contact field of the bipolar plate located between the valleys are in contact with the cathode-electrolyte-anode unit. In order to reduce the electrical transfer resistances, a nickel netting or a nickel paste will be used on the anode side. At the operating conditions on the anode side (temperature of 600 to 900° C., partial pressure of the oxygen of 10-14 bars) the nickel netting or the nickel paste are present in a metallic form and, therefore, in a ductile and flexible form. On the cathode side, the peaks of the bipolar plate are provided with a so-called cathode contact layer (consisting of oxide ceramics). This is sintered during operation and binds the cathode-electrolyte-anode unit to the bipolar plate.

The stamping process, during which the bipolar plate is provided with a wave-like profile or nap-like profile, is inexpensive and suitable for mass production but it does allow only rounded profiles of the bipolar plate. Even after the cathode contact layer has been applied, less than 20% of the active cell surface area of the cathode-electrolyte-anode unit is connected to the bipolar plate. This 20% of the active cell surface area is, in addition, reduced by up to 50% as a result of compression processes during the sintering of the cathode contact layer and so only approximately 10% of the active cell surface area is then still in electrical contact with the bipolar plate. This reduces the contact surface area between the cathode-electrolyte-anode unit, on the one hand, and the bipolar plate, on the other hand, and results in a considerable loss of power of the fuel cell unit.

The object underlying the present invention is to create a fuel cell unit of the type specified at the outset which has a low contact resistance between the bipolar plate and an electrode of the cathode-electrolyte-anode unit.

This object is accomplished in accordance with the invention, in a fuel cell unit having the features of the preamble to claim 1, in that the fuel cell unit comprises at least one electrically conductive intermediate element which is arranged between the bipolar plate and the electrode and has at least one contact surface facing the electrode.

As a result of the intermediate element which is inserted between the bipolar plate and the electrode of the cathode-electrolyte-anode unit, the contact surface area available for the electrical contact between the bipolar plate and the electrode is increased in size which lowers the contact resistance and, therefore, increases the electrical output power of the fuel cell.

As a result of the increase in the size of the contact surface area between bipolar plate and cathode-electrolyte-anode unit due to the insertion of the intermediate element, the cathode-electrolyte-anode unit is less subject to bending when bending torque occurs (which can be caused, in particular, by production tolerances). As a result, a greater tensioning of the fuel cell stack is possible which is linked to an increase in the power of the stack.

The contact surface of the intermediate element, which faces the electrode of the cathode-electrolyte-anode unit, is preferably of an essentially flat design which leads to a particularly large surface area being made available for the electrical connection of the intermediate element and the cathode-electrolyte-anode unit.

Furthermore, it is favorable when the contact surface of the intermediate element is aligned essentially parallel to a surface of the electrode which faces the intermediate element. In this way, the distance between the intermediate element and the surface of the electrode facing the same is essentially of the same size overall.

As a result of a defined gap being set between the intermediate element and the surface of the electrode facing the same, the reproducibility of the production process of the fuel cell unit is improved.

In one preferred development of the invention it is provided for the at least one contact surface of the intermediate element to cover at least 25% of the active surface area of the electrode.

In this respect, the contact surface of the intermediate element can be of a connected design or be divided into several partial contact surfaces which are separate from one another.

It is particularly favorable when the at least one contact surface of the intermediate element covers at least 40% of the active surface area of the electrode.

In one preferred development of the invention it is provided for the intermediate element to be designed as an essentially flat plate with recesses. The recesses in the intermediate element enable gas (oxidizing agent or combustible gas) to pass through to the electrode.

When the intermediate element is connected directly to the basic material of the bipolar plate without any oxidation layer located therebetween, this offers the advantage that the transfer resistance between the intermediate element and the bipolar plate ceases which considerably reduces the overall contact resistance between the bipolar plate and the electrode in comparison with the use of intermediate layers, in particular, a cathode contact layer.

The material-locking connection between the intermediate element and the bipolar plate can be produced, in particular, in that the intermediate element is welded and/or soldered to the bipolar plate.

Since the flow of current does not take place via an oxide layer arranged between the intermediate layer and the bipolar plate but rather in the steel materials themselves when the intermediate element and the bipolar plate are connected, steel materials, which form electrically insulating oxide layers during operation of the fuel cell unit, for example, aluminum oxide or silicon oxide-forming steel materials, can also be used for the bipolar plate.

Different materials can be used for the intermediate element and for the bipolar plate on account of the material-locking connection between the intermediate element and the bipolar plate.

In order to achieve a sufficiently large tapping of current from the electrode, it may be provided, in particular, for the intermediate element to comprise a chromium oxide-forming steel material; the chromium oxide layer formed on the surface of a chromium oxide-forming steel material during operation of the fuel cell unit has, for example, a relatively high electrical conductivity.

The bipolar plate can, on the other hand, preferably comprise an aluminum oxide or silicon oxide-forming steel material which has a considerably lower chromium evaporation which could poison the cathode of the cathode-electrolyte-anode unit and, therefore, reduce the output of the cell.

The bipolar plate can have at least one opening which is closed by the at least one intermediate element. In this way, structures with an approximately trapezoidal cross section can be created, in particular, from the contact elements of the bipolar plate and from the intermediate element and these structures have a particularly large contact surface aligned essentially parallel to the free outer surface of the electrode but cannot be produced by way of stamping procedures.

When the intermediate element is advantageously connected to the electrode by means of a metallic solder, this offers the advantage that the cathode-electrolyte-anode unit is floatingly mounted on the bipolar plate on account of the ductility of the metallic solder, whereby excessive local mechanical loads (for example, on account of the thermal cycling of the fuel cell stack) can be compensated.

A window-like metal sheet framing the intermediate element can likewise be connected to the electrolyte of the cathode-electrolyte-anode unit by means of a metallic solder.

It may be provided, in particular, for the cathode-electrolyte-anode unit to be connected to the window-like metal sheet and also the electrode, in particular, the cathode of the cathode-electrolyte-anode unit to be connected to the intermediate element at the same time in a single soldering procedure.

Alternatively or in addition to a connection of the intermediate element to the electrode of the cathode-electrolyte-anode unit by way of a metallic solder, it may also be provided for the intermediate element to be connected to the electrode by means of a ceramic contact layer which is electrically conductive at the operating temperature of the fuel cell unit.

During the soldering of the intermediate element to the electrode, the intermediate element and the cathode will preferably be pressed against one another with a contact pressure of at least 2 N/cm².

As a result of this, the intermediate element can be caused to track the cathode-electrolyte-anode unit during the soldering process and so contact losses as a result of compression processes are avoided.

Even when the intermediate element is connected to the electrode by means of a ceramic contact layer, the intermediate element and the cathode will be pressed against one another during the sintering process, preferably with a contact pressure of at least 2 N/cm², whereby a reduction in the size of the contact surface between the intermediate element and the electrode on account of compression processes during the sintering will be avoided.

The electrode, which is located opposite the intermediate element and connected to the intermediate element in an electrically conductive manner, is preferably the cathode of the cathode-electrolyte-anode unit.

The present invention also relates to a method for producing an electrically conductive connection between an electrode of a cathode-electrolyte-anode unit of a fuel cell unit and a bipolar plate.

The additional object underlying the present invention is to create such a method, by means of which a low contact resistance between the electrode and the bipolar plate will be achieved.

This object is accomplished in accordance with the invention by a method for producing an electrically conductive connection between an electrode of a cathode-electrolyte-anode unit of a fuel cell unit and a bipolar plate which comprises the following method steps:
material-locking connection of an electrically conductive intermediate element, which has at least one contact surface facing the electrode, to the electrode;
material-locking connection of the intermediate element to the bipolar plate.

The fuel cell unit according to the invention is suitable, in particular, for use in a high-temperature fuel cell, in particular, an SOFC (Solid Oxide Fuel Cell) with an operating temperature of, for example, at least 600° C.

Additional features and advantages of the invention are the subject matter of the following description and the drawings illustrating embodiments.

In the drawings:

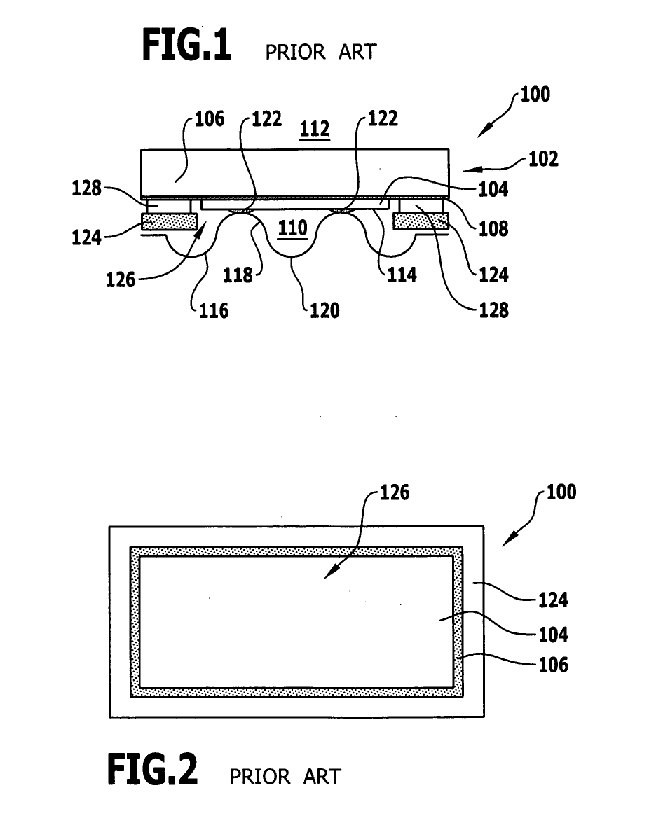

FIG. 1 shows a schematic cross section through a cathode-electrolyte-anode unit of a fuel cell unit and a bipolar plate connected to the cathode of the cathode-electrolyte-anode unit in an electrically conductive manner in accordance with the state of the art;

FIG. 2: shows a plan view of the cathode side of the cathode-electrolyte-anode unit from FIG. 1 and a window-like metal sheet framing the cathode-electrolyte-anode unit;

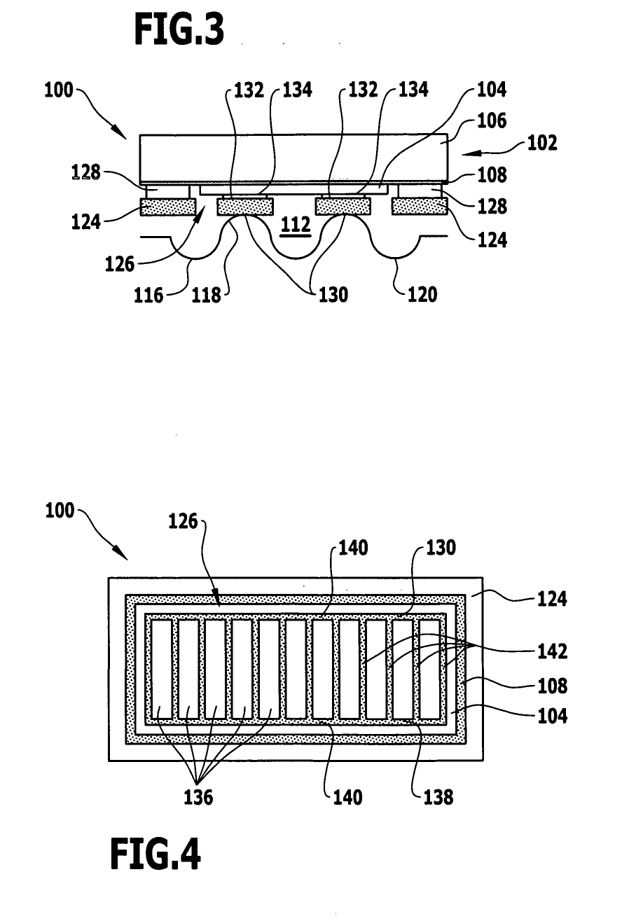

FIG. 3: shows a schematic cross section through a cathode-electrolyte-anode unit of a fuel cell unit and a bipolar plate connected to the cathode of the cathode-electrolyte-anode unit in an electrically conductive manner by means of an intermediate element in the form of a strip of sheet metal;

FIG. 4: shows a schematic plan view of the cathode side of the cathode-electrolyte-anode unit from FIG. 3 and the intermediate element arranged on the cathode side in the form of a strip of sheet metal;

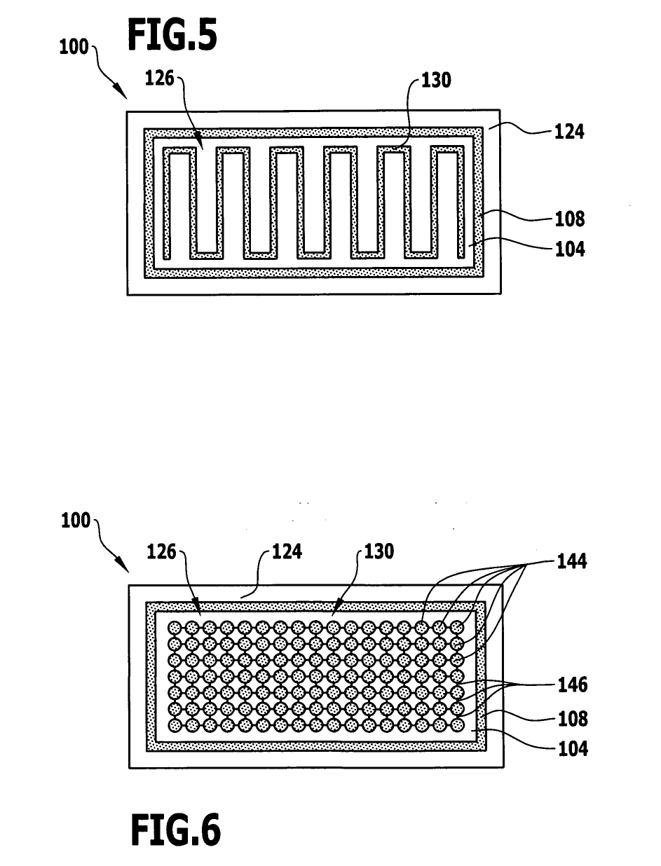

FIG. 5: shows a schematic plan view of the cathode side of a cathode-electrolyte-anode unit and an intermediate element arranged on the cathode side in a meandering form;

FIG. 6: shows a schematic plan view of the cathode side of a cathode-electrolyte-anode unit and an intermediate element arranged on the cathode side and having a plurality of circular contact surfaces;

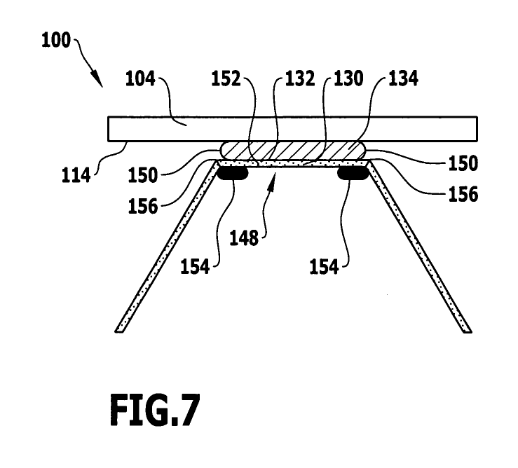

FIG. 7: shows a schematic cross section through a bipolar plate with an opening and an intermediate element which closes the opening and is fixed to the bipolar plate in a material-locking manner as well as a cathode located opposite the intermediate element.

The same or functionally equivalent elements are designated in all the Figures with the same reference numerals.

A fuel cell unit according to the state of the art, which is illustrated in FIGS. 1 and 2 and designated as a whole as 100, comprises a cathode-electrolyte-anode unit (CEA unit) 102 which, for its part, comprises a cathode 104, an anode 106 and an electrolyte 108 which is arranged between the cathode 104 and the anode 106.

The cathode 104 is formed from a ceramic material, for example, from (La_{0.8}Sr_{0.2})_{0.9}MnO₃ which is electrically conductive at the operating temperature of the fuel cell unit 100 (of, for example, approximately 800° C. to approximately 900° C.) and is porous in order to enable an oxidizing agent, for example, air or pure oxygen to pass to the electrolyte 108 from a chamber 110 for oxidizing agent adjacent to the cathode 104.

The electrolyte 108 is preferably designed as a solid state electrolyte, in particular, as a solid state oxide electrolyte and consists, for example, of zirconium dioxide stabilized by yttrium.

The electrolyte 108 is electronically non-conductive at a normal temperature as well as at operating temperature of the fuel cell unit 100. On the other hand, its ionic conductivity increases with an increasing temperature.

The anode 106 is formed from a ceramic material, for example, from ZrO₂ or from a Ni/ZrO₂ ceramet (a metal ceramics mixture) which is electrically conductive at the operating temperature of the fuel cell unit 100 and is porous in order to enable a combustible gas to pass from a chamber 112 for combustible gas through the anode 106 to the electrolyte 108 adjoining the anode 106.

As is apparent from FIG. 1, the cathode 104 covers a considerably smaller surface area of the electrolyte 108 than the anode 106.

Therefore, the entire surface area of the cathode 104 is essentially electrochemically active and the active surface area of the cathode 104 corresponds essentially to the size of the free outer surface 114 of the cathode 104 facing away from the electrolyte 108.

A bipolar plate (also designated as interconnector) 116 is connected to the cathode 104 in an electrically conductive manner and has a central contact field with contact elements 118, which project towards the cathode 104 and are, for example, nap-like or like wave peaks, and troughs 120 arranged between the contact elements 118.

Each of the contact elements 118 of the bipolar plate 116 is connected to the free outer surface 114 of the cathode 104 via a respective cathode contact layer 122 consisting of a ceramic material which is electrically conductive at the operating temperature of the fuel cell unit 100.

As is apparent from FIGS. 1 and 2, the central contact field of the bipolar plate 116 is surrounded by a frame-like, window-like metal sheet 124 which is essentially rectangular and consists of a metallic material and which—when seen from the cathode side of the CEA unit—covers the area of the anode 106 projecting laterally beyond the cathode 104.

The window-like metal sheet 124 has an essentially rectangular, central window opening 126, through which the contact elements 118 of the bipolar plate 116 extend to the cathode 104.

The window-like metal sheet 124 is fixed to the electrolyte 108 of the CEA unit 102 by means of a solder layer 128 consisting of a metallic solder.

Since the contact elements 118 of the bipolar plate 116 are produced by means of a stamping process and, therefore, have a rounded profile, less than 20% of the active surface area of the cathode 104 is covered by the cathode contact layers 122.

As a result of compression processes during the sintering of the cathode contact layer 122, the surface area of the cathode contact layers 122 actually in contact with the cathode 104 is reduced by up to 50%. As a result, only approximately 10% of the active surface area of the cathode 104 is in electrically conductive contact with the bipolar plate 116. The contact surface area between cathode 104 and bipolar plate 116, which is reduced in size in this way, leads to a considerable loss of power of the fuel cell unit 100.

In the embodiment of a fuel cell unit 100 illustrated in FIGS. 3 and 4, the bipolar plate 116 is not connected directly to the cathode 104 but rather indirectly via an intermediate element 130 which is arranged between the bipolar plate 116 and the cathode 104.

The intermediate element 130 is formed from an electrically conductive, metallic material.

The intermediate element 130 has a contact surface 132 which is located opposite the cathode 104, is essentially flat and aligned parallel to the free outer surface 114 of the cathode 104 and is connected to the cathode 104 in a material-locking manner via a contact layer 134 which is arranged between the intermediate element 130 and the cathode 104 and consists of a contact material which is electrically conductive at the operating temperature of the fuel cell unit 100.

A metallic solder can, for example, be used as contact material for the contact layer 134.

A suitable, metallic solder material for generating the contact layer 134 is, for example, a silver-based solder, in particular, the silver-based solder with the designation Ag4CuO which is marketed by the company Innobraze GmbH, Germany, under the article number PA 9999999 and has the following composition: 96 mol % of Ag; 4 mol % of CuO.

Alternatively to forming the contact layer 134 from a metallic solder, a ceramic material in the form of a contact paste can also be used as contact material.

Such a contact paste for forming the contact layer 134 contains, for example, 50% by weight of a ceramic powder, 47% by weight of terpineol and 3% by weight of ethyl cellulose.

Mn₂O₃ can be used, for example, as ceramic powder.

Apart from manganese oxide, the ceramic powder can also contain additions of copper oxide (CuO) and/or cobalt oxide (Co₃O₄).

When copper oxide is added to manganese oxide, the molar ratio of manganese and copper is preferably Mn/Cu=2/1. When cobalt oxide is added to manganese oxide, the molar ratio of manganese and cobalt is preferably Mn/Co=1/2.

The contact material can be applied selectively to the contact surface 132 of the intermediate element 130 in a pattern printing process, for example, in a screen printing process.

In this respect, the contact paste is applied by means of a screen printing apparatus which is known to the person skilled in the art, wherein the mesh density of the screen can, for example, be 18 meshes/cm² and the mesh thickness approximately 0.18 mm.

The contact layer 134 is preferably produced with a wet layer thickness of approximately 100 μm.

The intermediate element 130 is produced from a metallic material, preferably from a steel material.

In order for the tapping of current from the cathode 104 to be adequately high, a chromium oxide-forming steel material is preferably used as material for the intermediate element 130.

The following chromium oxide-forming steels are suitable, in particular, as basic material for the intermediate element 130:
The steel with the designation Crofer22APU of the manufacturer ThyssenKrupp AG, Germany, with the following composition: 22.2% by weight of Cr; 0.02% by weight of Al; 0.03% by weight of Si; 0.46% by weight of Mn; 0.06% by weight of Ti; 0.002% by weight of C; 0.004% by weight of N; 0.07% by weight of La; 0.02% by weight of Ni; the rest iron.
The steel with the designation Crofer22APU has the material designation 1.4760 according to EN standards and S44535 according to the UNS.
The steel with the designation F17TNb of the manufacturer Imphy Ugine Precision, France, with the following composition: 17.5% by weight of Cr; 0.6% by weight of Si; 0.24% by weight of Mn; 0.14% by weight of Ti; 0.17% by weight of C; 0.02% by weight of N; 0.47% by weight of Nb; 0.08% by weight of Mo; the rest iron.
The steel with the designation F17TNb has the material designation 1.4509 according to EN standards, 441 according to the AISI and S44100 according to the UNS.
The steel with the designation IT-11 of the manufacturer Plansee AG, Austria, with the following composition: 25.9% by weight of Cr; 0.02% by weight of Al; 0.01% by weight of Si; 0.28% by weight of Ti; 0.08% by weight of Y; 0.01% by weight of C; 0.02% by weight of N; 0.01% by weight of Mo; 0.16% by weight of Ni; the rest iron.
The steel with the designation Ducrolloy (ODS) of the manufacturer Plansee AG, Austria, with the following composition: 5.5% by weight of Fe; 0.48% by weight of Y; 0.01% by weight of C; 0.01% by weight of N; the rest Cr.

The intermediate element 130 is designed in the form of an essentially flat plate which has an essentially rectangular outer contour and is provided with a plurality of essentially rectangular recesses 136 (cf., in particular, FIG. 4) and so the intermediate element 130 has the shape of a strip of sheet metal 138 which is formed from two longitudinal strips 140 and from a plurality of transverse strips 142 which connect the longitudinal strips 140 to one another.

The contact field of the bipolar plate 116 is, in this embodiment, preferably provided with a wave-like profile, wherein the wave peaks extending parallel to the longitudinal strips 140 of the intermediate element 130 form the contact elements 118 of the bipolar plate 116.

As a result of the recesses 136 provided between the transverse strips 142, oxidizing agent can pass from the chamber 112 for combustible gas, which is formed between the contact elements 118 of the bipolar plate 116, to the cathode 104 during operation of the fuel cell unit 100.

On its side facing away from the cathode 104 and the contact layers 134, the intermediate element 130 is connected to the bipolar plate 116 in a material-locking manner, namely in the area of the contact elements 118 of the bipolar plate.

This material-locking connection can be generated, in particular, by welding, in particular, laser welding and/or by soldering of the bipolar plate 116 to the intermediate element 130.

As in the case of the embodiment according to the state of the art which is illustrated in FIGS. 1 and 2, a window-like metal sheet 124 with a window opening 126 surrounds the central contact field of the bipolar plate 116 and the intermediate element 130 arranged between the bipolar plate 116 and the cathode 104 in the embodiment illustrated in FIGS. 3 and 4.

As is apparent in FIG. 3, it may be provided, in particular, for the window-like metal sheet 124 and the intermediate element 130 to have essentially the same material thickness.

Furthermore, the intermediate element 130 is preferably arranged within the window opening 126 of the window-like metal sheet 124 so as to be at the same height as the window-like metal sheet 124.

The material-locking connection between the intermediate element 130 and the bipolar plate 116 is generated such that the basic metallic material of the intermediate element 130 is connected directly to the basic metallic material of the bipolar plate 116 without any oxide layer located therebetween.

Since, in this way, the contact resistance between the intermediate element 130 and the bipolar plate 116 is not increased by any oxide layer which is formed on the bipolar plate 116 during operation of the fuel cell unit 100, the bipolar plate 116 can be produced, in particular, from an aluminum oxide or silicon oxide-forming steel material since the high electrical resistance of the layer, which is formed on the free outer surface of the bipolar plate 116 and consists of aluminum oxide or silicon oxide, does not have any unwanted effect on account of the direct connection of the metallic material of the bipolar plate 116 to the metallic material of the intermediate element 130.

For this purpose, aluminum oxide or silicon oxide-forming steel materials offer the advantage that no volatile chromium species, which can cause a degradation in the power of the fuel cell unit 100 as a result of cathode poisoning, will volatilize from these materials during operation of the fuel cell unit 100.

The following aluminum oxide-forming steel is suitable, in particular, as basic material for the bipolar plate 116:

The steel with the designation Aluchrom YHf of the manufacturer ThyssenKrupp AG, Germany, with the following composition: 19% by weight of Cr; 5.5% by weight of Al; less than 0.5% by weight of Si; less than 0.5% by weight of Mn; less than 0.1% by weight of Y; less than 0.05% by weight of C; less than 0.01% by weight of N; less than 0.3% by weight of Ni; less than 0.07% by weight of Zr; less than 0.1% by weight of Hf; the rest iron.

A hot shaping process is carried out on the sheet metal consisting of the basic material of the bipolar plate 116 in order to form the contact elements 118 in the contact field of the bipolar plate 116, at which the finished bipolar plate 116 is connected to the intermediate element 130 in an electrically conductive manner.

To produce an electrically conductive connection between the cathode 104 of the CEA unit 102 and the bipolar plate 116, the procedure is as follows:

A contact material, for example, the contact paste described above, which contains a ceramic powder, is applied to the free outer surface 114 of the cathode 104 and/or the contact surface 132 of the intermediate element 130.

Subsequently, the intermediate element 130 is placed against the free outer surface 114 of the cathode 104 and the intermediate element 130 and the cathode 104 of the CEA unit 102 are pressed against one anther at a contact pressure of at least 2 N/cm².

In the state pressed against one another, the CEA unit 102 and the intermediate element 130 are heated in a sintering oven to a sintering temperature of, for example, approximately 900° C.

The CEA unit 102 and the intermediate element 130 and the contact material arranged therebetween are kept at this sintering temperature during a holding period of approximately 5 hours, whereby the layer consisting of the contact material is sintered and the contact layer 134 formed therefrom.

The heating to the sintering temperature can be brought about, for example, at a rate of heating of 3 K/min.

Following the holding period, the arrangement consisting of the CEA unit 102, the intermediate element 130 and the contact layer 134 arranged therebetween will be cooled to the ambient temperature in an unregulated manner.

Subsequently, the window-like metal sheet 124 will be soldered to the CEA unit 102 by means of a metallic solder, thereby forming a solder layer 128.

Finally, the bipolar plate 116, into which the contact elements 118 are stamped, will be placed against the free outer surface of the intermediate element 130, which faces away from the cathode 104, and connected to the intermediate element 130 in a material-locking manner, for example, by way of welding, in particular, by way of laser welding.

As a result of this material-locking connection between the bipolar plate 116 and the intermediate element 130, the electrical transfer resistance between the bipolar plate 116 and the intermediate element 130 ceases and so a considerably lower contact resistance is achieved than with the use of intermediate layers consisting, for example, of a ceramic contact material.

The side of the bipolar plate 116 facing away from the intermediate element 130 can be connected directly or indirectly (via an electrically conductive contact structure, for example, a contact netting) to the anode 106 of a further fuel cell unit 100 adjacent to the fuel cell unit 100 in an electrically conductive manner, for example, by way of soldering or by means of a contact layer consisting of a contact material which is electrically conductive at the operating temperature of the fuel cell unit 100.

In this way, a fuel cell stack can be formed from a plurality of fuel cell units 100 which follow one another in a stacking direction.

Instead of a ceramic contact paste, a metallic solder of the type described above, for example, the silver-based solder with the designation Ag4CuO can also be used as contact material for the formation of the contact layer 134 between the intermediate element 130 and the cathode 104.

The intermediate element 130 and the cathode 104 are also pressed against one another at a contact pressure of at least 2 N/cm² during the soldering of the intermediate element 130 to the cathode 104.

As a result of the intermediate element 130 and the cathode 104 being pressed together, for example, by means of a load resting on the CEA unit 102 or the intermediate element 130 during the material-locking connection of intermediate element 130 and cathode 104, the intermediate element 130 can be caused to track the CEA unit 102, whereby contact losses as a result of compression processes during the sintering or soldering procedure are avoided.

As a result of a defined gap width being set between the intermediate element 130 and the cathode 104 and, therefore, a defined thickness of the contact layer 134, the reproducibility of the production method for the fuel cell unit 100 will be improved.

The soldering of the window-like metal sheet 124 to the CEA unit 102 can take place at the same time as the soldering of the intermediate element 130 to the cathode 104.

A second embodiment of a fuel cell unit 100 illustrated in FIG. 5 differs from the first embodiment illustrated in FIGS. 3 and 4 in that the intermediate element 130 does not have the shape of a rectangular strip of sheet metal 138 but rather, instead, a meandering shape.

As for the rest, the second embodiment of a fuel cell unit 100 illustrated in FIG. 5 corresponds to the first embodiment illustrated in FIGS. 3 and 4 with respect to construction, functioning and mode of manufacture and reference is made to its description above in this respect.

A third embodiment of a fuel cell unit 100 illustrated in FIG. 6 differs from the first embodiment illustrated in FIGS. 3 and 4 in that the intermediate element 130 is not designed as a strip of sheet metal but rather comprises a plurality of essentially circular partial contact surfaces 144, wherein partial contact surfaces 144 which are arranged adjacent to one another are connected to one another each time by a thin web 146.

Each of the partial contact surfaces 144 of the intermediate element 130 of this embodiment is connected in a material-locking manner to one of the respective contact elements 118 of the bipolar plate 116 by way of welding and/or soldering.

Consequently, the contact field of the bipolar plate 116 is, in this embodiment, preferably provided with nap-like contact elements 118.

A particularly low contact resistance between the bipolar plate 116 and the cathode 104 is achieved as a result of the association of a respective, circular partial contact surface 144 of the intermediate element 130 with a respective contact element 118 of the bipolar plate 116.

As for the rest, the third embodiment of a fuel cell unit 100 illustrated in FIG. 6 corresponds to the first embodiment illustrated in FIGS. 3 and 4 with respect to construction, functioning and mode of manufacture and reference is made to its description above in this respect.

A fourth embodiment of a fuel cell unit 100 illustrated in FIG. 7 differs from the embodiments described above in that the contact field of the bipolar plate 116 is not of a closed design but, instead, has openings 148, of which one is illustrated in FIG. 7.

These openings 148 can, for example, extend in a strip-like manner through the contact field of the bipolar plate 116.

Each of the openings 148 is closed each time by a section of the intermediate element 130 which is adapted to the shape of the opening 148, i.e., for example, by a strip-like section 152 of the intermediate element 130.

The edges 150 of the section 152 of the intermediate element 130 are connected in a material-locking manner to an adjoining edge 156 of the bipolar plate 116, which limits the opening 148 of the bipolar plate 116, by way of welding seams 154.

In this way, it is possible to create structures with an approximately trapezoidal cross section, which cannot be achieved by way of stamping procedures, from the contact elements 118 of the bipolar plate 116 and the intermediate element 130.

As a result of the fact that the sections 152 of the intermediate element 130 of such an essentially trapezoidal structure are aligned essentially parallel to the free outer surface 114 of the cathode 104, a large contact surface area is achieved between the trapezoidal structure, on the one hand, and the cathode 104, on the other hand, and, therefore, a low contact resistance between the bipolar plate 116 and the cathode 104.

In this embodiment, as well, the intermediate element 130 is connected to the cathode 104 in an electrically conductive manner via a contact layer 134 consisting of a metallic solder consisting of a ceramic contact material which is electrically conductive at the operating temperature of the fuel cell unit 100.

In the case of the fourth embodiment illustrated in FIG. 7, the bipolar plate 116 is also preferably formed from an aluminum oxide-forming steel material in order to prevent any chromium evaporation and the intermediate element 130 is preferably formed from a chromium oxide-forming steel material in order achieve a low, electrical transfer resistance between the intermediate element 130 and the contact layer 134 (on account of the relatively high electrical conductivity of the chromium oxide layer formed on the surface of the intermediate element 130).

As for the rest, the fourth embodiment of a fuel cell unit 100 illustrated in FIG. 7 corresponds to the first to third embodiments illustrated in FIGS. 2 to 6 with respect to construction, functioning and mode of manufacture and reference is made to their description above in this respect.

1. Fuel cell unit, comprising a cathode-electrolyte-anode unit and at least one bipolar plate connected to an electrode of the cathode-electrolyte-anode unit in an electrically conductive manner, wherein the fuel cell unit comprises at least one electrically conductive intermediate element arranged between the bipolar plate and the electrode, said intermediate element having at least one contact surface facing the electrode.

2. Fuel cell unit as defined in claim 1, wherein the contact surface of the intermediate element is essentially of a flat design.

3. Fuel cell unit as defined in claim 1, wherein the contact surface of the intermediate element is aligned essentially parallel to a surface of the electrode facing the intermediate element.

4. Fuel cell unit as defined in claim 1, wherein the at least one contact surface of the intermediate element covers at least 25% of the active surface area of the electrode.

5. Fuel cell unit as defined in claim 4, wherein the at least one contact surface of the intermediate element covers at least 40% of the active surface area of the electrode.

6. Fuel cell unit as defined in claim 1, wherein the intermediate element is designed as an essentially flat plate with recesses.

7. Fuel cell unit as defined in claim 1, wherein the intermediate element is connected to the bipolar plate without any oxidation layer located therebetween.

8. Fuel cell unit as defined in claim 1, wherein the intermediate element is welded and/or soldered to the bipolar plate.

9. Fuel cell unit as defined in claim 1, wherein the intermediate element comprises a chromium oxide-forming steel material.

10. Fuel cell unit as defined in claim 1, wherein the bipolar plate comprises an aluminum oxide or silicon oxide-forming steel material.

11. Fuel cell unit as defined in claim 1, wherein the bipolar plate has at least one opening closed by the at least one intermediate element.

12. Fuel cell unit as defined in claim 1, wherein the intermediate element is connected to the electrode by means of a metallic solder.

13. Fuel cell unit as defined in claim 1, wherein the intermediate element is connected to the electrode by means of a ceramic contact layer electrically conductive at the operating temperature of the fuel cell unit.

14. Fuel cell unit as defined in claim 1, wherein the electrode located opposite the intermediate element is the cathode of the cathode-electrolyte-anode unit.

15. Method for producing an electrically conductive connection between an electrode of a cathode-electrolyte-anode unit of a fuel cell unit and a bipolar plate, comprising the following method steps:
material-locking connection of an electrically conductive intermediate element to the electrode, said intermediate element having at least one contact surface facing the electrode;
material-locking connection of the intermediate element to the bipolar plate.
